(19) United States
(12) Patent Application Publication
(10) Pub. No.: US 2010/0000850 A1
(43) Pub. Date: Jan. 7, 2010

(54) Method Of Improving Rectifier Column Performance In An Ethanol Plant

(75) Inventors: D. Christopher Romer, Memphis, TN (US); Richard Hopkins, Marionville, MO (US)

Correspondence Address: AIR LIQUIDE;Intellectual Property, 2700 POST OAK BOULEVARD, SUITE 1800, HOUSTON, TX, 77056, US

(73) Assignee: Lurgi PSI, Inc., Memphis, TN (US)

(21) Appl. No.: 12/495,865

(22) Filed: Jul. 1, 2009

Related U.S. Application Data
(60) Provisional application No. 61/077,986, filed on Jul. 3, 2008.

(51) Int. Cl. B01D 3/42

(52) U.S. Cl. 203/2

(57) ABSTRACT

A method for improving rectifier column performance including positioning a temperature controller on the rectifier column feed tray, wherein said temperature controller is outside the fusel draw region, and controlling distillate composition or temperature, wherein said control is cascaded to the rectifier column flow control is provided.

This application claims the benefit of U.S. Provisional Application No. 61/077,986, filed Jul. 3, 2008, the entire contents of which are incorporated herein by reference.

### BACKGROUND

A variety of cereal grains and other plants are grown for use as food. Major cereal grains include corn, rice, wheat, barley, sorghum (milo), millets, oats, and rye. Other plants include potatoes, cassava, and artichokes. Corn is the most important cereal grain grown in the United States. A mature corn plant consists of a stalk with an ear of corn encased within a husk. The ear of corn consists of about 800 kernels on a cylindrical cob. The kernels are eaten whole and are also processed into a wide variety of food and industrial products. The other parts of the corn plant (i.e., the stalk, leaves, husk, and cob) are commonly used for animal feed, but are sometimes processed into a variety of food and industrial products.

In more detail, the corn kernel consist of three main parts: (1) the pericarp; (2) the endosperm; and (3) the germ. The pericarp (also known as the seed coat or bran) is the outer covering of the kernel. It consists primarily of relatively coarse fiber. The endosperm is the energy reserve for the plant. It consists primarily of starch, protein (also known as gluten), and small amounts of relatively fine fiber. The germ (also known as the embryo) consists primarily of oil and a miniature plant with a root-like portion and several embryonic leaves.

Starch is stored in a corn kernel in the form of discrete crystalline bodies known as granules. Starch is a member of the general class of carbohydrates known as polysaccharides. Polysaccharides contain multiple saccharide units (in contrast to disaccharides which contain two saccharide units and monosaccharides which contain a single saccharide unit). The length of a saccharide chain (the number of saccharide units in it) is sometimes described by stating its “degree of polymerization” (abbreviated to D.P.). Starch has a D.P. of 1000 or more. Glucose (also known as dextrose) is a monosaccharide (its D.P. is 1). Saccharides having a D.P. of about 5 or less are sometimes referred to as sugars.

As mentioned above, the pericarp and endosperm of the corn kernel contain fiber. The fiber comprises cellulose, hemicellulose, lignin, pectin, and relatively small amounts of other materials. Fiber is present in relatively small amounts in the corn kernel, but is present in much greater amounts in other corn components such as the cob, husk, leaves, and stalk. Fiber is also present in other plants. The combination of cellulose and lignin is sometimes known as lignocellulose and the combination of cellulose, lignin, and hemicellulose is sometimes known as lignocellulosic biomass. As used herein, the term “fiber” (and its alternative spelling “fibre”) refers to cellulose, hemicellulose, lignin, and pectin.

A wide variety of processes have been used to separate the various components of corn. These separation processes are commonly known as corn refining. One of the processes is known as the dry milling process. In this process, the corn kernels are first cleaned and then soaked in water to increase their moisture content. The softened corn kernels are then ground in coarse mills to break the kernel into three basic types of pieces—pericarp, germ, and endosperm. The pieces are then screened to separate the relatively small pericarp and germ from the relatively large endosperm. The pericarp and the germ are then separated from each other. The germs are then dried and the oil is removed. The remaining germ is typically used for animal feed. The endosperm (containing most of the starch and protein from the kernel) is further processed in various ways. As described below, one of the ways is to convert the starch to glucose and then ferment the glucose to ethanol.

Fermentation is a process by which microorganisms such as yeast digest sugars to produce ethanol and carbon dioxide. Yeast reproduce aerobically (oxygen is required) but can conduct fermentation anaerobically (without oxygen). The fermented mixture (commonly known as the beer mash) is then distilled to recover the ethanol. Distillation is a process in which a liquid mixture is heated to vaporize the components having the highest vapor pressures (lowest boiling points). The vapors are then condensed to produce a liquid that is enriched in the more volatile compounds.

With the ever-increasing depletion of economically recoverable petroleum reserves, the production of ethanol from vegetative sources as a partial or complete replacement for conventional fossil-based liquid fuels becomes more attractive. In some areas, the economic and technical feasibility of using a 90% unleaded gasoline-10% anhydrous ethanol blend (“gasohol”) has shown encouraging results. According to a recent study, gasohol powered automobiles have averaged a 5% reduction in fuel compared to unleaded gasoline powered vehicles and have emitted one-third less carbon monoxide than the latter. In addition to offering promise as a practical and efficient fuel, biomass-derived ethanol in large quantities and at a competitive price has the potential in some areas for replacing certain petroleum-based chemical feedstocks. Thus, for example, ethanol can be catalytically dehydrated to ethylene, one of the most important of all chemical raw materials both in terms of quantity and versatility.

### SUMMARY

The present invention is a method for improving rectifier column performance including positioning a temperature controller on the rectifier column feed tray, wherein said temperature controller is outside the fusel draw region, and controlling distillate composition or temperature, wherein said control is cascaded to the rectifier column flow control.

### DESCRIPTION OF PREFERRED EMBODIMENTS

Often a rectifier column will use what is known in the art as a Material Balance (MB) control scheme. This is to say, the product (distillate) composition is controlled by manipulating the flow of material in and out of the column. Specifically, it is common to use a direct MB control that uses a temperature controller to regulate the distillate stream and a level controller to regulate the bottoms stream. In such a process scheme, the reflux is adjusted automatically in response to changes in composition regulated by the temperature controller.

The key streams in and out of the rectifier column are typically controlled as follows:
Reflux—drum level control
Bottoms—sump level control
Distillate—composition (temperature) control cascaded to flow control
Heat input—flow control
OH Condensation—pressure control

This control scheme is commonly used in the ethanol industry and typically works well, provided feed conditions remain steady, composition control location is correct, surge volumes are adequate and control loops are tuned correctly.

In practice, it is not unusual for the cascade control of the distillate stream to prove to be unstable and will often be disengaged. As a result, often the system, or a subordinate system, will be operating in a non-MB mode, which requires operator interface in order to maintain the column temperature profile and product quality.

One reason for the cascade loop not to function as intended may be due, primarily, to oscillations in feed rate and feed composition that disturb the master controller. The following indicators would support this:
1. The rectifier column feed rate may be similar to the column reflux rate, and, as such, would constitute a large fraction of the column internal flow rate. Under such conditions, any changes in feed rate or feed composition will have a significant impact on the vapor-liquid traveling across the feed point. One option would be to have the temperature controller a few trays above the feed. This configuration would allow the temperature controller to respond quickly to changing feed conditions. However, if care is not taken, the control point may also be inside the fusel draw region of the column which adds a degree of instability when the fusel draw location changes. A more optimum option would be to have the temperature controller on the same tray as the feed. This may provide a less sensitive position, but this remains a responsive location that is now outside the fusel draw region.
2. The rectifier column feed is typically a combination of condensed beer column overhead vapors, condensed molesieve regen vapors and fusel water recycle. The condensed beer column overheads may fluctuate slightly during molesieve cycling due to load changes on the reboiler and the regen condensate rate fluctuates during sieve bed depressurization. In addition, regen liquid proof is typically quite high (possibly greater than 180 proof) at the start of depressurization, dropping overtime to about 100 proof. The above streams are typically collected in a rectifier feed tank, which may have a total capacity of 3 minutes residence time at average rate. Computer trends show rectifier feed tank level control valve may have to open 4%-5% every 6 minutes to deal with fluctuations in level.

In order to absorb oscillations in the regen flow and the regen proof, one embodiment includes the addition of surge volume to Regen Tank, by piping to a local unused tank. In addition, the response to cyclic changes may be dampened in level by tuning a level controller for flow averaging level control over two or more molesieve cycles (typically 12 minutes or so), or;

A more costly, but more effective, option is to add a larger rectifier feed tank that can absorb the 6 minute fluctuations in both beer column overheads and regen flow with minimal impact to tank volume. The new tank with pump and level control would be installed downstream of the rectifier feed tank. The level control may be tuned to flow averaging level control over a 12 minute period.
3. The control scheme typically needs to respond to a temperature disturbance by changing column liquid traffic (increase or decrease reflux). This change must travel with the liquid from tray to tray until it reaches the control point. As there may typically be about 20 trays above the control point, this information could take up to 3 minutes to reach the control point. However, often the feed rate/composition changes every 6 mins coincident with the molesieve cycles. Under such conditions, such a control scheme will struggle to stabilize the column. A more optimum option would be to have the sensor location on the same tray as the feed. Also, the temperature control loop must be properly tuned to account for a 3 minute lag in feedback (or whatever the delay is calculated to be), and cyclic changes in feed must be sufficiently dampened.

What is claimed is:

1. A method for improving rectifier column performance comprising:
positioning a temperature controller on the rectifier column feed tray, wherein said temperature controller is outside the fusel draw region, p1 controlling distillate composition or temperature, wherein said control is cascaded to the rectifier column flow control.

2. The method for improving rectifier column performance of claim 1, wherein said control comprises a control loop that is tuned for a predetermined lag in feedback.

3. The method for improving rectifier column performance of claim 2, wherein said predetermined feedback lag is 3 minutes.

4. The method for improving rectifier column performance of claim 1, wherein said temperature controller is positioned two trays above the feed tray.

5. The method for improving rectifier column performance of claim 1, wherein said rectifier column has a feed stream, and wherein said feed stream has any cyclic feed changes dampened.

6. The method for improving rectifier column performance of claim 5, wherein said cyclic feed change dampening comprises:
providing a rectifier feed tank, wherein said feed tank
providing a condensed molesieve regen condensed vapor stream, wherein said condensed molesieve regen condensed vapor stream has a first predetermined cycle frequency of φ minutes, and wherein said condensed molesieve regen condensed vapor stream enters said rectifier feed tank,
providing a beer column overhead stream, wherein said beer column overhead stream has a first predetermined fluctuation frequency of β, and wherein said beer column overhead stream enters said rectifier feed tank,
providing a fusal water recycle flow, wherein said fusal water recycle flow enters said rectifier feed tank,
utilize at least one control scheme selected from the group consisting of:
adding at least one additional storage tank in parallel, such that the total storage volume is sufficient to provide a residence time greater than (φ+β) minutes,
tuning the level controller for said rectifier feed tank for flow averaging control over a period greater than (φ+β) minutes, and
tuning the level controller for said rectifier feed tank for flow averaging control over a period greater than (φ+β) minutes, and ensuring that rectifier feed tank is of sufficient volume to provide a residence time greater than (φ+β) minutes.

7. The method for improving rectifier column performance of claim 6, wherein (φ+β) equals 12 minutes.
